(19) United States
(12) Patent Application Publication
(10) Pub. No.: US 2019/0220843 A1
(43) Pub. Date: Jul. 18, 2019

(54) MOBILE DEVICE PAYMENT SYSTEM AND METHOD

(71) Applicants: Sanjeev Kaithvas, Singapore (SG); Karthik Venkataraman, Singapore (SG); Daya Venkatesan, Singapore (SG); Ashok Babu Mundru, Singapore (SG); Chen Xu, Singapore (SG)

(72) Inventors: Sanjeev Kaithvas, Singapore (SG); Karthik Venkataraman, Singapore (SG); Daya Venkatesan, Singapore (SG); Ashok Babu Mundru, Singapore (SG); Chen Xu, Singapore (SG)

(21) Appl. No.: 15/874,569

(22) Filed: Jan. 18, 2018

(51) Int. Cl. G06Q 20/32; G06Q 20/02; G06Q 20/38

(52) U.S. Cl. CPC G06Q 20/3226; G06Q 30/0226; G06Q 20/3821; G06Q 20/02

(57) ABSTRACT

A payment system may intelligently monitor text conversations on other applications or a user's email system. Users and participating merchants may enroll credit cards or other payment devices, bank accounts, etc., with the payment system. Once enrolled, a daemon/plugin of the payment system may monitor text applications, emails, or other communication means of the mobile computing device. Using Artificial Intelligence (AI) and Machine Learning algorithms, the payment system may determine payment information from a text or other communication, and initiate and/or complete a payment transaction between the communicating parties. Upon confirmation, the payment system may complete the funds transfer or payment to registered users or merchants in the text communication. The payment system may also integrate with a merchant's loyalty and reward programs and use these loyalty/reward points as forms of payment.

### BACKGROUND

Mobile computing devices such as smartphones have shaped the way users interact with each other in an “online” world and how they conduct personal business. For example, a smartphone may include an electronic wallet application executing on the device that links it to physical payment devices such as credit cards. In some transactions, a user must cause the electronic wallet application to respond to an input from a near-field communication reader at a checkout or take some other action in response to passive input to complete a payment. In other transactions, the user activates the electronic wallet application or other payment application on his or her mobile computing device and directs the application to complete a payment.

While mobile devices and electronic wallet applications have made payment transactions simple and convenient, they still present the technical problem of being separated from other systems and applications on the device and not integrated with the full communications capabilities of the device. In other words, current electronic wallet payment systems fail to detect or understand the payment intent of the user. As such, electronic wallet and other payment systems are not integrated with users' social media and other communications that are often used to discuss payments among friends.

### SUMMARY

The following presents a simplified summary of the present disclosure in order to provide a basic understanding of some aspects of the disclosure. This summary is not an extensive overview. It is not intended to identify key or critical elements of the disclosure or to delineate its scope. The following summary merely presents some concepts in a simplified form as a prelude to the more detailed description provided below.

The present disclosure provides a technical solution to the technical problem of electronic wallet integration with the communications capabilities of mobile computing devices. A payment system may intelligently monitor text conversations on other applications or a user's email system (WhatsApp, Gmail, Outlook etc.). Users and participating merchants may enroll credit cards or other payment devices, bank accounts, etc., with the payment system. Once enrolled, a daemon/plugin of the payment system may monitor text applications, emails, or other communication means of the mobile computing device. Using Artificial Intelligence (AI) and Machine Learning algorithms, the payment system may determine payment information from a text or other communication, and initiate and/or complete a payment transaction between the communicating parties. Upon confirmation, the payment system may complete the funds transfer or payment to registered users or merchants in the text communication. The payment system may also integrate with a merchant's loyalty and reward programs and use these loyalty points/reward points program(s) as forms of payment.

In some embodiments, a computer-implemented method may complete a payment transaction between parties via communication analysis. The method may intercept communication data between a sender and a receiver and identify one or more of a sender unique identification and a receiver unique identification from the communication data. The method may then pull one or more of sender profile data corresponding to the sender unique identification and receiver profile data corresponding to the receiver unique identification and identify transaction data within the communication data, the transaction data including a transaction amount. The method may then determine which of the sender or the receiver receives the transaction amount and which of the sender or the receiver sends the transaction amount, and sends a confirmation request to one of the sender or the receiver that sends the transaction amount. In response to receiving a positive response to the confirmation request, the method may process a payment for the transaction amount.

In other embodiments, a system may complete a payment transaction between parties via communication analysis. The system may include a mobile computing device including a processor and a memory storing instructions that, when executed by the processor, causes the processor perform various functions. In some embodiments, instructions may cause the processor to intercept communication data between a sender and a receiver and identify one or more of a sender unique identification and a receiver unique identification from the communication data. The instructions may then cause the processor to pull one or more of sender profile data corresponding to the sender unique identification and receiver profile data corresponding to the receiver unique identification and identify transaction data within the communication data, the transaction data including a transaction amount. The instructions may then cause the processor to determine which of the sender or the receiver receives the transaction amount and which of the sender or the receiver sends the transaction amount, and sends a confirmation request to one of the sender or the receiver that sends the transaction amount. In response to receiving a positive response to the confirmation request, the instructions may then cause the processor to process a payment for the transaction amount.

### FIGURES

The invention may be better understood by references to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1 shows an illustration of an exemplary payment system for initiating payments and other funds transfers via message and other communication analysis;

FIG. 2A shows an illustration of an exemplary web browser component for the payment system of FIG. 1;

FIG. 2B shows an illustration of an exemplary mobile computing device component for the payment system of FIG. 1;

FIG. 3A shows a first view of an exemplary payment device for use with the system of FIG. 1;

FIG. 3B shows a second view of an exemplary payment device for use with the system of FIG. 1;

FIG. 4 shows an exemplary process flowchart for user enrollment and registration with the payment system of FIG. 1;

FIG. 5 shows an exemplary process flowchart for merchant enrollment and integration with the payment system of FIG. 1;

FIG. 6 shows a first exemplary process flowchart for payment processing with the payment system of FIG. 1;

FIG. 7 shows a second exemplary process flowchart for payment processing with the payment system of FIG. 1;

FIG. 8 shows an exemplary sequence diagram for payment processing with the payment system of FIG. 1; and

FIG. 9 shows an exemplary computing device that may be physically configured to execute the methods and include the various components described herein.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein.

### SPECIFICATION

The present invention now will be described more fully with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, computer readable media, apparatuses, components, or devices. Accordingly, the present invention may take the form of an entirely hardware embodiment, an entirely software embodiment, or an embodiment combining software and hardware aspects. The following detailed description is, therefore, not to be taken in a limiting sense.

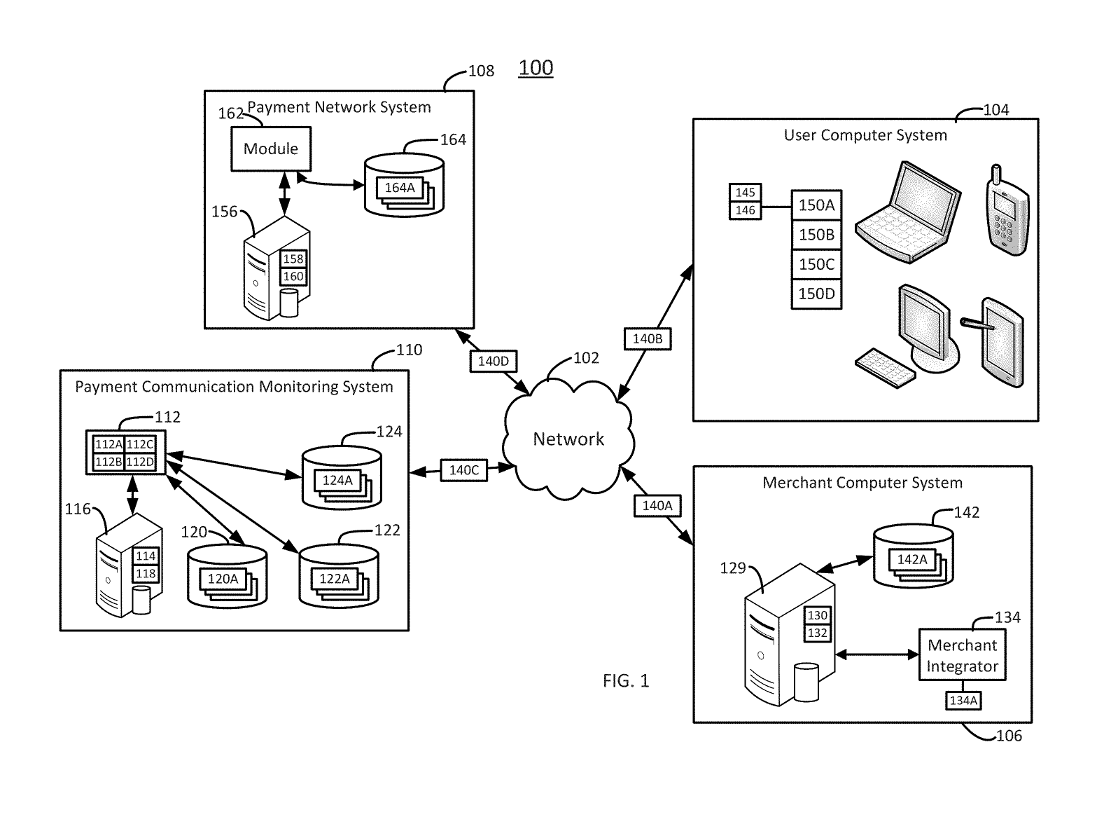

FIG. 1 generally illustrates one embodiment of a payment system 100 for completing payments and other funds transfers based on communications between payment parties. The system 100 may include a computer network 102 that links one or more systems and computer components. In some embodiments, the system 100 includes a user computer system 104, a merchant computer system 106, a payment network system 108, n in-store payment system 104, a user computing device 106, and a payment network computer system 108, and a payment communication monitoring system 110.

The network 102 may be described variously as a communication link, computer network, internet connection, etc. The system 100 may include various software or computer-executable instructions or components stored on tangible memories and specialized hardware components or modules that employ the software and instructions to securely complete payment transactions initiated by monitoring communications between enrolled users as well as users and merchants, as described herein.

The various modules may be implemented as computer-readable storage memories containing computer-readable instructions (i.e., software) for execution by one or more processors of the system 100 within a specialized or unique computing device. The modules may perform the various tasks, methods, modules, etc., as described herein. The system 100 may also include both hardware and software applications, as well as various data communications channels for communicating data between the various specialized and unique hardware and software components.

The payment communication monitoring computer system 110 may include one or more instruction modules including a control module 112 that, generally, may include instructions to cause a processor 114 of a payment processing server 116 to functionally communicate with a plurality of other computer-executable steps or sub-modules, e.g., sub-modules 112A, 112B, 112C, and components of the system 100 via the network 102. These modules 112A, 112B, 112C may include instructions that, upon loading into the server memory 118 and execution by one or more computer processors 114, identify possible payment transactions between various users and/or merchants that may be processed by the payment network system 108. For example, sub-modules may include a user enrollment module 112A, a merchant enrollment module 1128, an artificial intelligence and machine learning module 112C, etc. A first data repository 122, a second data repository 122, and a third data repository 124 may store data for enrolled users of the system 100. In some embodiments, the different repositories may correspond to different types of enrolled users such as private users, merchants, businesses, etc. A first data repository 120 may include user profile data 120A that each include various pieces of data to describe an account of a primary account holder and user of the system 100 (i.e., a private user, a merchant business, etc.) as received and/or using the user enrollment module 112A or other component of the system 100. A second data repository 122 may include user account data 122A that each include various pieces of data to describe an account of another account holder of the system 100 (i.e., a private user, a merchant business, etc.) as received and/or derived using the merchant enrollment module 1128. Various other data 124A may be received and/or derived by the machine learning module and stored in a third data repository 124 and used by the system 100 as described herein. For example, the third data repository may be used to store transaction details 124A from a user message 140B or a merchant message 140A, as described herein.

The merchant computer system 106 may include a computing device such as a merchant server 129 including a processor 130 and memory 132 including components to facilitate payment transactions with the user computer system 104 via the payment communication monitoring system 110 and the payment network system 108. In some embodiments, the memory 132 may include a merchant integrator module 134. In some embodiments, the payment communication monitoring system 110 may provision the merchant integrator module 134 to one or more entities of the system 100. For example, the merchant computer system 106 may receive the merchant integrator module from the payment communication monitoring system 110 during an enrollment process, as described herein. The merchant integrator module 134 may also include instructions to send merchant messages 140A to the user computer system 104 and the payment communication monitoring system, receive user messages 140B from the user computer system 104, receive payment messages 140D form the payment network system 108, and store payment and other transaction data 142A within a transaction repository 142.

The user computer system 104 may also include a processor 145 and memory 146. The user computing system 104 may include a server, a mobile computing device, a smartphone, a tablet computer, a Wi-Fi-enabled device or other personal computing device capable of wireless or wired communication, a thin client, or other known type of computing device. The memory may include various modules including instructions that, when executed by the processor 145, control the functions of the user computer system generally and integrate the user computer system 104 into the payment system 100 in particular. For example, some modules may include an operating system 150A, a browser module 150B, a communication module 150C, and a text payment module 150D. In some embodiments, the text payment module 150D and its functions described herein may be incorporated as one or more modules of the user computer system 104. In other embodiments, the text payment module 150D and its functions described herein may be incorporated as one or more sub-modules of the control module 112 within the payment communication monitoring system 110.

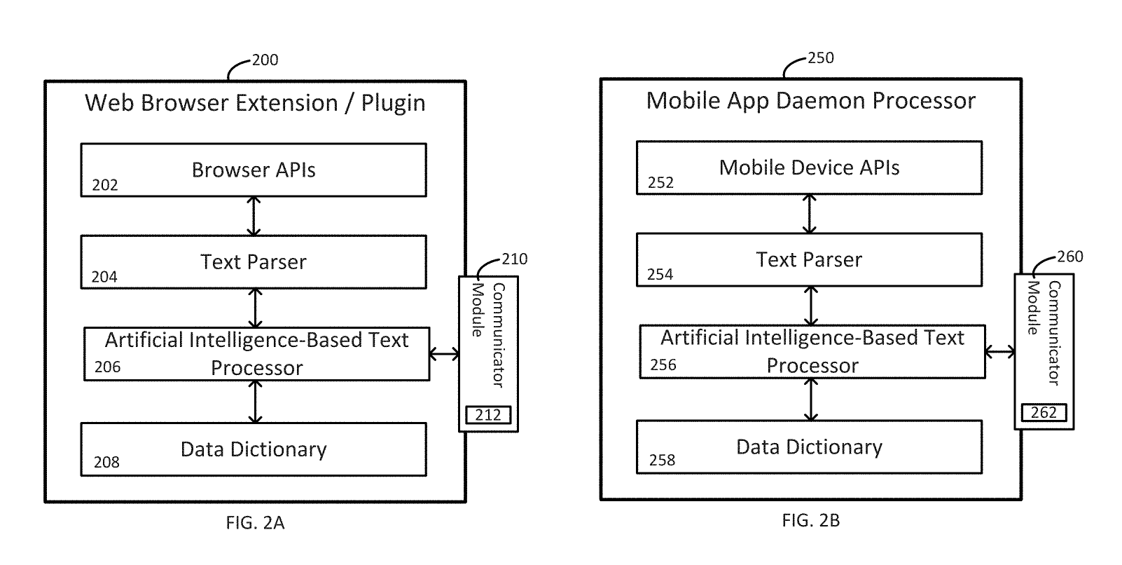

With brief reference to FIGS. 2A and 2B, the text payment module 150D may include a web browser extension 200 or a mobile app daemon 250. Each of the web browser extension 200 and mobile app daemon 250 may include sub-modules to integrate the user computer system 104 into the payment system 100.

For example, the web browser extension 200 may include browser APIs 202, a browser text parser 204, an artificial intelligence (AI)-based browser text processor 206, and a data browser dictionary 208. The web browser extension 200 may also include a browser communicator module 210 to send and receive messages (e.g., messages 140A, 140B, 140C, 140D, etc.) between the various components of the system 100. In some embodiments, the browser APIs 202 may include instructions to integrate the module 200 within the browser module 150B of the user computer system 104. The browser text parser 204 may include instructions to parse user messages 140B that are received from the communication module 150C. The AI-based browser text processor 206 may include instructions to use data from the browser data dictionary 208 and the browser text parser 204 to determine browser extension payment data 212. In some embodiments, the browser extension payment data 212 may include a payment amount, receiving party data, sending party data, account data, invoice data, or any other data that may facilitate payment to/from one or more user computer systems 104 and/or one or more merchant computer systems 106.

Like the web browser extension 200, the mobile app daemon 250 may include mobile device APIs 252, a mobile device text parser 254, an artificial intelligence (AI)-based mobile text processor 256, and a mobile data dictionary 258. The mobile app daemon 250 may also include a mobile communicator module 260 to send and receive messages (e.g., messages 140A, 140B, 140C, 140D, etc.) between the various components of the system 100. In some embodiments, the mobile device APIs 252 may include instructions to integrate the module 250 within the operating system 150A of the user computer system 104. The mobile device text parser 254 may include instructions to parse user messages 140B that are received from the communication module 150C. The AI-based mobile text processor 256 may include instructions to use data from the mobile device data dictionary 258 and the mobile device text parser 254 to determine mobile app daemon payment data 262. In some embodiments, the mobile app daemon payment data 262 may include a payment amount, receiving party data, sending party data, account data, invoice data, or any other data that may facilitate payment to/from one or more user computer systems 104 and/or one or more merchant computer systems 106.

Returning to FIG. 1, the payment network system 108 may include a payment server 156 including a processor 158 and memory 160. The memory may include a payment network module 162 including instructions to facilitate payment between parties (e.g., one or more users, merchants, etc.) using the payment system 100. The module 162 may be communicably connected to an account holder data repository 164 including account holder data 164A. The account holder data 164A may include any data to facilitate payment and other funds transfers between system users. For example, the account holder data 164A may include identification data, account history data, payment device data, etc. The module 162 may also include instructions to send payment messages 140D to other entities and components of the system 100 in order to complete transactions between users and/or merchants.

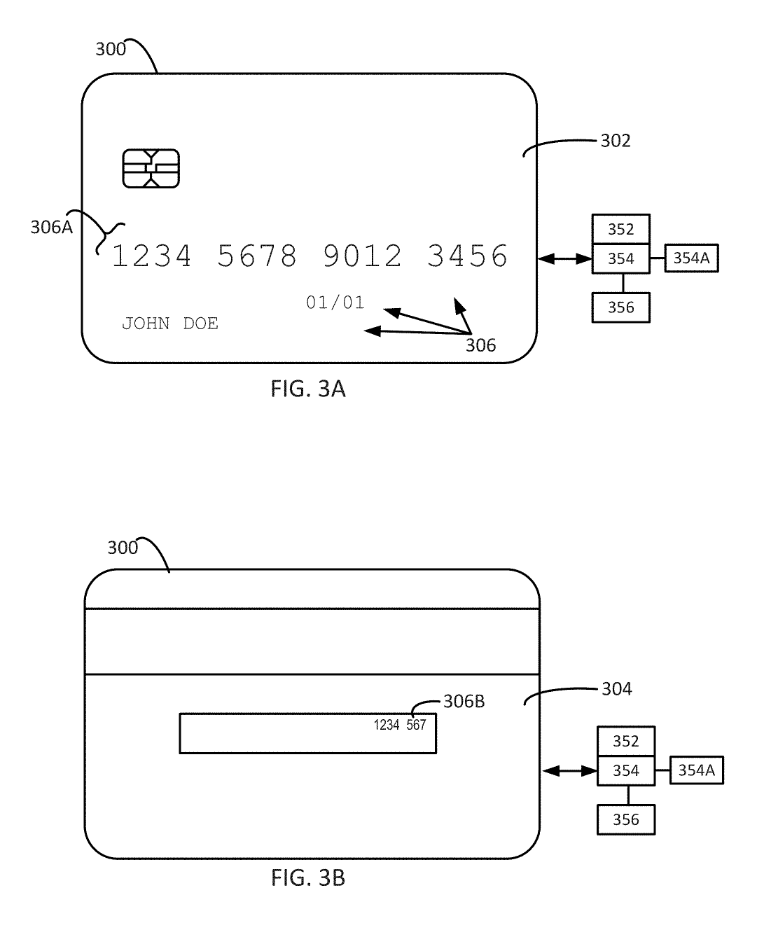

With brief reference to FIGS. 3A and 3B, an exemplary payment device 300 may take on a variety of shapes and forms. In some embodiments, the payment device 300 is a traditional card such as a debit card or credit card. In other embodiments, the payment device 300 may be a fob on a key chain, an NFC wearable, or other device. As long as the payment device 300 is able to communicate securely with the system 100 and its components, the form of the payment device 300 may not be especially critical and may be a design choice. For example, many legacy payment devices may have to be read by a magnetic stripe reader and thus, the payment device 300 may have to be sized to fit through a magnetic card reader. In other examples, the payment device 300 may communicate through near field communication and the form of the payment device 300 may be virtually any form. Of course, other forms may be possible based on the use of the card, the type of reader being used, etc.

Physically, the payment device 300 may be a card and the card may have a plurality of layers to contain the various elements that make up the payment device 300. In one embodiment, the payment device 300 may have a substantially flat front surface 302 and a substantially flat back surface 304 opposite the front surface 202. Logically, in some embodiments, the surfaces 302, 304 may have some embossments 306 including a personal account number (PAN) 306A and the card verification number (CVN) 306B. In some embodiments, the payment device 300 may include data corresponding to the primary account holder, such as account holder data 164A for the account holder. A memory 354 generally and a module 354A in particular may be encrypted such that all data related to payment is secure from unwanted third parties. A communication interface 356 may include instructions to facilitate sending payment data 140D, such as a payment payload, a payment token, or other data to identify payment information to one or more components of the system 100 via the network 102.

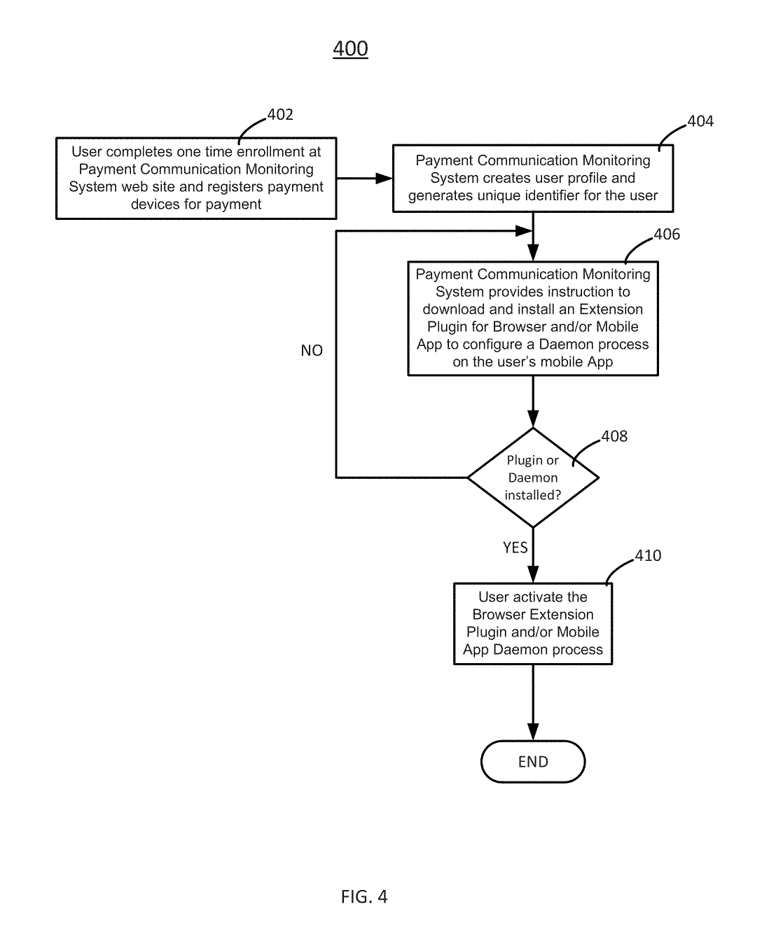

With reference to FIG. 4, a user enrollment and registration method 400 may enroll and register one or more user computer systems 104 for using the system 100. Each step of the method 400 may be performed on a server or other computing device including instructions that, when executed by a processor perform the action or block described herein.

At block 402, the method 400 may receive user enrollment data for creating a user profile 120A in the first data repository 120 at the payment communication monitoring system 110. In some embodiments, the user computer system 104 may access a website 112D of the payment communication monitoring system 110 and enter account holder data 164A or other identifying data such as data from a payment device 300. Account holder data 164A may also include user preferences and payment amount thresholds.

At block 404, the method 400 may create user profile data 120A for the enrollment data received at block 402. The method may also generate a unique identifier for each set of user profile data 120A. The unique identifier may be linked to other user information such as an email address, a mobile phone number, a name, address, unique location, MAC address, biometric information, demographics, or any other information that may link a particular individual to the unique identifier.

At block 406, the method 400 may send instructions to download and install one or more of the web browser extension 200 and/or the mobile app daemon 250 at the user computer system 104.

At block 408, the method 400 may confirm whether the web browser extension 200 and/or the mobile app daemon 250 have been installed at the user computer system 104. In some embodiments, the user computer system 104 may send a checksum or other data indicating confirmation of proper installation to the payment communication monitoring system 110. If, at block 408, the method 400 determines that the web browser extension 200 and/or the mobile app daemon 250 have not been installed at the user computer system 104, then the method may return to block 406. If, at block 408, the method 400 determines that the web browser extension 200 and/or the mobile app daemon 250 have been properly installed at the user computer system 104, then the method may proceed to block 410.

At block 410, the system 100 may receive an activation instruction from the user computing system 104 generally and the web browser extension 200 and/or the mobile app daemon 250 in particular.

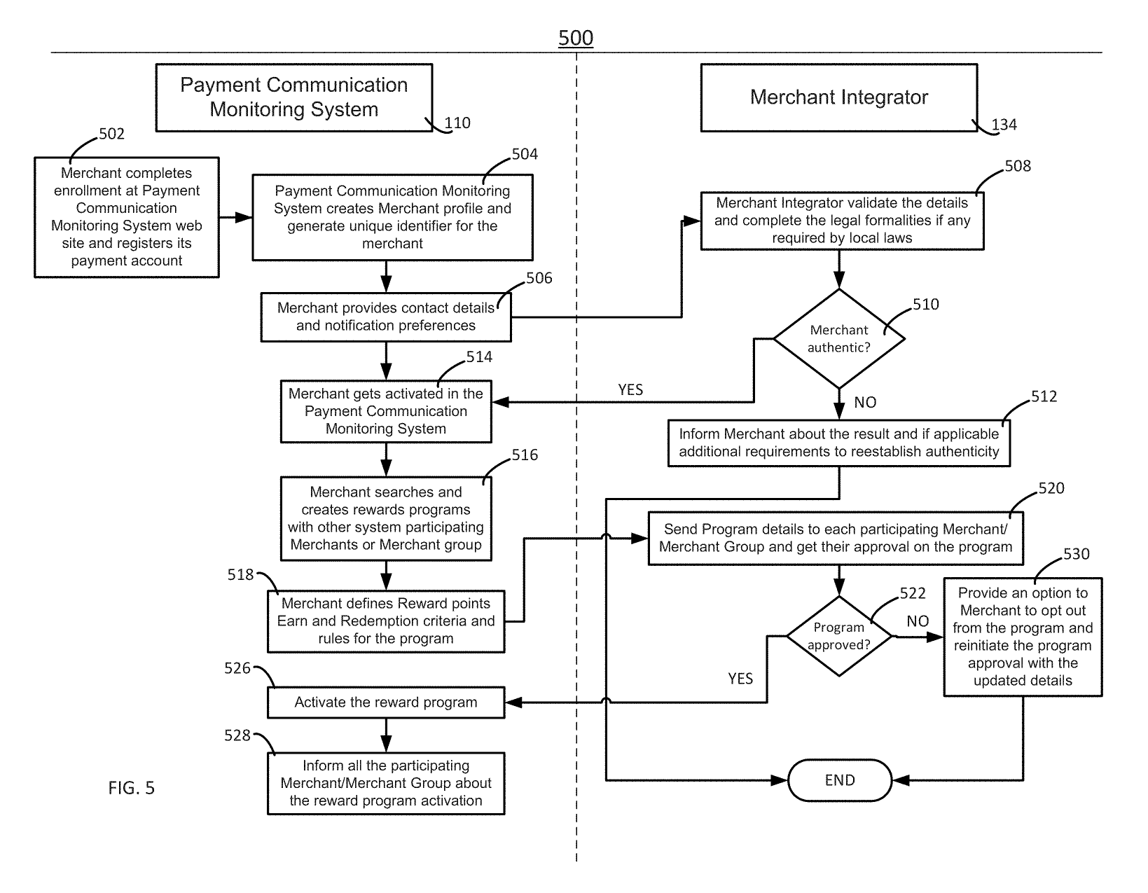

With reference to FIG. 5, a merchant enrollment and integration method 500 may enroll and integrate one or more merchant computer systems 106 for using the system 100. Each step of the method 500 may be performed on a server or other computing device including instructions that, when executed by a processor perform the action or block described herein.

At block 502, the payment communication and monitoring system 110 may receive merchant enrollment data for creating a merchant profile 122A in the second data repository 122 at the payment communication monitoring system 110. In some embodiments, the merchant computer system 106 may access a website 112D of the payment communication monitoring system 110 and enter account holder data 164A or other identifying data such as data from a payment device 300.

At block 504, the method 500 may create merchant profile data 122A for the enrollment data received at block 502. The method may also generate a unique identifier for each set of merchant profile data 122A.

At block 506, the method 500 may receive contact details and notification preferences for the merchant profile data 122A received at block 504. At block 508, the merchant integrator module 134 may execute an instruction to validate the merchant profile data 122A and complete any legal formalities (e.g., privacy notices, etc.) required by local laws.

At block 510, the method may confirm the authenticity of the merchant and the merchant profile data 122A. In some embodiments, the merchant computer system 106 may confirm the merchant profile data 122A with other online resources such as business listings, business websites, etc. If, at block 510, the method 500 determines that the merchant profile data 122A is not authentic, then the method 500 may proceed to block 512. At block 512, the method 500 may send a message to the merchant computer system 106 indicating that authenticity authentication has failed. If, at block 510, the method 400 determines that the merchant profile data 122A is authentic, then the method 500 may proceed to block 514.

At block 514, the method 500 may execute an instruction to activate the merchant profile data 122A. The method 500 may then end or proceed to an optional rewards points or loyalty program enrollment for the merchant computer system 106, as described below with respect to blocks 516-528.

At block 516, the method 500 may receive one or more rewards program selections for the merchant. At block 518, the method 500 may receive data indicating criteria for earning rewards points and redemption rules for the rewards program selection received at block 516. In some embodiments, the payment communication monitoring system 110 may receive a rewards program selection and the criteria for earning rewards points and redemption rules from the merchant computer system 106 and save the selection to the merchant profile data 122A. In further embodiments,

At block 520, the method 500 may send program details to each participating merchant computer system 106 for the rewards program selection received at block 516. In some embodiments, the merchant integrator module 134 may receive the program details for the rewards program from the payment communication monitoring system 110. The method 500 may also save the details to the merchant profile data 122A.

At block 522, if the rewards program selection received at block 516 has been approved by all the participating merchant computer systems 106, then the method 500 may proceed to block 526 to activate the rewards program selection and then to block 528 to inform all participating merchant computer systems 106 that the rewards program is activated. If the rewards program selection received at block 516 has not been approved by all the participating merchant computer systems 106, then the method 500 may proceed to block 530 to provide an option for the merchant computer system 106 to opt out of the rewards program selection. In some embodiments, block 530 may also return to block 530 to reinitiate program approval with updated details including those merchant computer systems 106 that have approved the rewards program selection received at block 516.

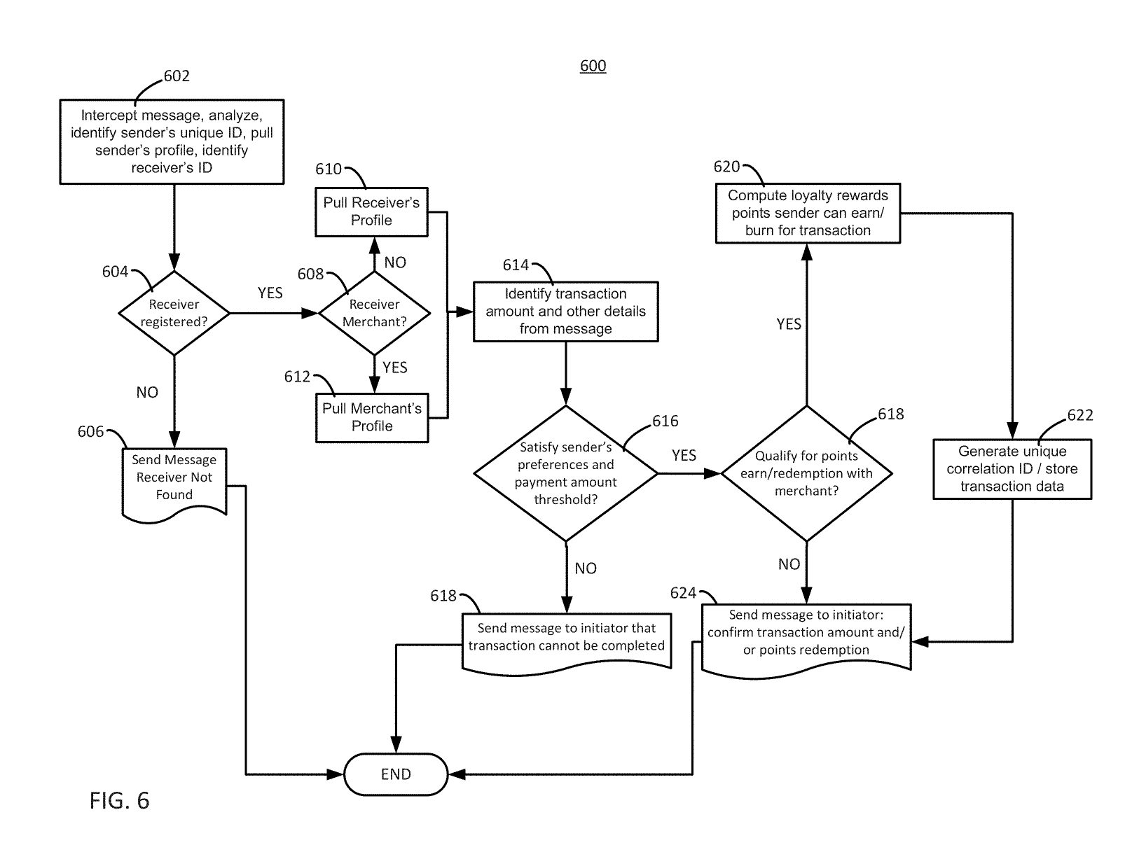

With reference to FIG. 6, a module of the payment communication monitoring system 110 (e.g., the artificial intelligence and machine learning module 112C or other module) may include a method 600 to process communications from one or more user computer systems 104 and/or one or more merchant computer systems 106 to complete a payment transaction. Each step of the method 600 may be performed on a server or other component of the system 100 including instructions that, when executed by a processor, perform the action or block described herein.

At block 602, the method 600 may intercept a user message 140B that was sent from a user computer system 104 to another system (e.g., another user computer system 104, a merchant computer system 106, etc.). The user message 140B may be a text-based message (e.g., SMS, e-mail, text-based chat message, etc.), a voice or video message (e.g., a voicemail, a live video conference, etc.) or other type of communication that includes discernable text or audio that may be parsed into constituent words, phrases, numbers, etc.). One or more of the browser text parser 204 or the mobile device text parser 254 may parse the message before sending the user message 140 to the payment communication monitoring system 110. In some embodiments, the payment communication monitoring system 110 may receive the user message 140B as parsed by the text payment module 105D at the user computer system. In other embodiments, the payment communication monitoring system 110 may receive the user message 140B and execute a plurality of instructions with the user message 140B. For example, the artificial intelligence and machine learning module 112C may analyze the user message 140B and identify both a sender and a receiver's unique identification from within the message itself or from data related to the message such as an address, phone number, name, MAC address, or other information as described herein. Block 602 may also cause the method 600 to pull user profile data 120A that corresponds to the unique identifiers (i.e., both sender and receiver data). Block 602 may also cause the method to identify the receiver's unique identifier based on information within the user message 140B (e.g., message addressing, a connection of the user computer system 104 to another computer system, etc.).

At block 604, the method 600 may determine if the receiver identified by block 602 is registered with the system 100 generally or the payment communication monitoring system 110 specifically. In some embodiments, block 604 may cause the method 600 to scan a data repository (e.g., one or more of the first, second, or third data repositories: 120, 122, 124, respectively) for a receiver's unique identifier. If, the receiver's unique identifier is not found, then at block 606, the method 600 may send a message indicating the receiver was not found to one or more components of the system 100 and the method 600 may end. If, at block 604, the receiver's unique identifier is found, then the method 600 may proceed to block 608.

At block 608, the method may determine whether the receiver identified at block 602 is a merchant or corresponds to a merchant computer system 106. If not, then block 610 may execute an instruction to pull user profile data 120A from the first data repository 120. If the receiver identified at block 602 is a merchant or corresponds to a merchant computer system 106, then block 612 may execute an instruction to pull merchant profile data 122A from the second data repository 122. If the receiver identified at block 602 is some other category of registered user, then the method 600 may execute an instruction to pull various other data 124A corresponding to the receiver's unique identifier from the third data repository 124 (e.g., transaction data 124A).

At block 614, the method 600 may identify a transaction amount and other details from the user message 140B. In some embodiments, the text payment module 150D or other component of the system 100 (e.g., the artificial intelligence (AD-based browser text processor 206 and data browser dictionary 208, and/or the artificial intelligence (AI)-based mobile text processor 256 and mobile data dictionary 258) may scan the parsed user message 140B to identify the transaction amount and other details. For example, the artificial intelligence (AI)-based browser text processor 206 may use natural language processing or other techniques on the message 140B to determine whether the sender or receiver should receive payment, how much the payment should be, a timing for the payment, etc.

If, at block 616, the transaction amount and other details from the user message 140B do not satisfy user preferences and payment amount thresholds of the user profile 120A, then the method 600 may send a failure message to the sender of the message at block 618 and end. If, at block 616, the transaction amount and other details from the user message 140B satisfy user preferences and payment amount thresholds of the user profile 120A, then the method 600 may proceed to block 618.

At block 618, if the merchant profile data 122A pulled at block 612 includes an indication that the transaction of the user message 140B or the merchant message 140A qualifies for a loyalty points or rewards program, then, at block 620, the method 600 may cause the merchant integrator 134 to execute instructions to compute loyalty rewards points that may be earned or used for the transaction. At block 622, the control module 112 may execute an instruction to generate a unique correlation identification and store the transaction details 124A from the user message 140B or the merchant message 140A in the third data repository 124.

At block 618, if the merchant profile data 122A pulled at block 612 includes an indication that the transaction of the user message 140B or the merchant message 140A does not qualify for a loyalty points or rewards program, then, at block 622, the method 600 may send a confirmation request message to the user computer system 104, the confirmation request asking approval for a transaction amount and loyalty points redemption.

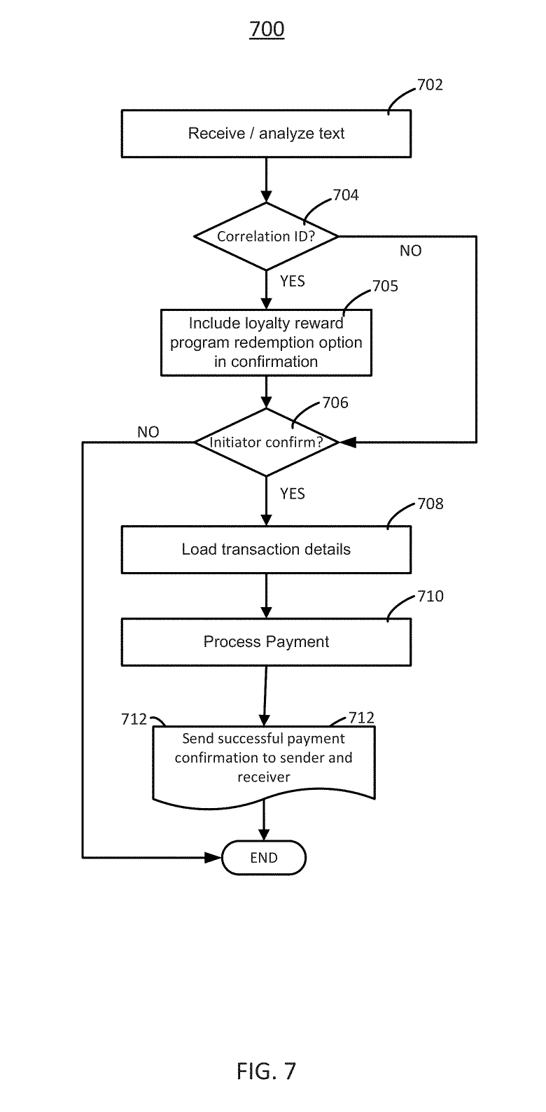

With reference to FIG. 7, a module of the system 100 generally and the payment communication monitoring system 110 (e.g., the artificial intelligence and machine learning module 112C or other module) in particular may include a method 700 to complete a transaction using the message including the correlation identification and other data processed by the method 600. Each step of the method 700 may be performed on a server or other component of the system 100 including instructions that, when executed by a processor, perform the action or block described herein.

At block 702, the method 700 may receive one or more of a user message 140B and a merchant message 140A and analyze the message(s). If, at block 704, the method determines that no correlation identification for a loyalty rewards program is present in the message (140A and/or 140B), then the method may proceed to block 706.

If, at block 704, the method determines that the correlation identification for a loyalty rewards program is present in the message (140A and/or 140B), then the method may send a confirmation message to the payer and include a loyalty reward program redemption option within the confirmation message at block 705.

At block 706, the method 700 may request confirmation from the user computer system 104 that sent the message 140B to continue and process the payment transaction with a transaction amount. If applicable, the method 700 may also request confirmation from the user computer system 104 that sent the message 140B to continue the transaction with a loyalty point redemption at block 706. If the method 700 receives confirmation to continue with the transaction, then the method may proceed to block 708.

At block 708, the method 700 may load the transaction data and other data into a message 140C to send to the payment network system 108. At block 710, the method 700 may process the payment transaction identified by the user message 140B and/or merchant message 140A at the payment network system 108 and proceed to block 712. In some embodiments, block 710 may include the payment communication monitoring system 110 sending transaction data 124A to the payment network system 108 within the message 140C. At the payment network system 108, the payment network module 162 may process the transaction data 124A using account holder data 164A corresponding to the party sending the funds indicated in the user message 140B and/or the merchant message 140A that was processed by the payment communication monitoring system 110 and the text payment module 150D. The payment network system 108 may then send a payment message 140D including data to complete the transaction (e.g., a payment payload, a payment token, or other data to identify payment information for the transaction data 124A).

At block 712, the method 700 may send a message indicating successful payment confirmation to the sender of the original transaction request (e.g., a user computer system 104 or a merchant computer system 106).

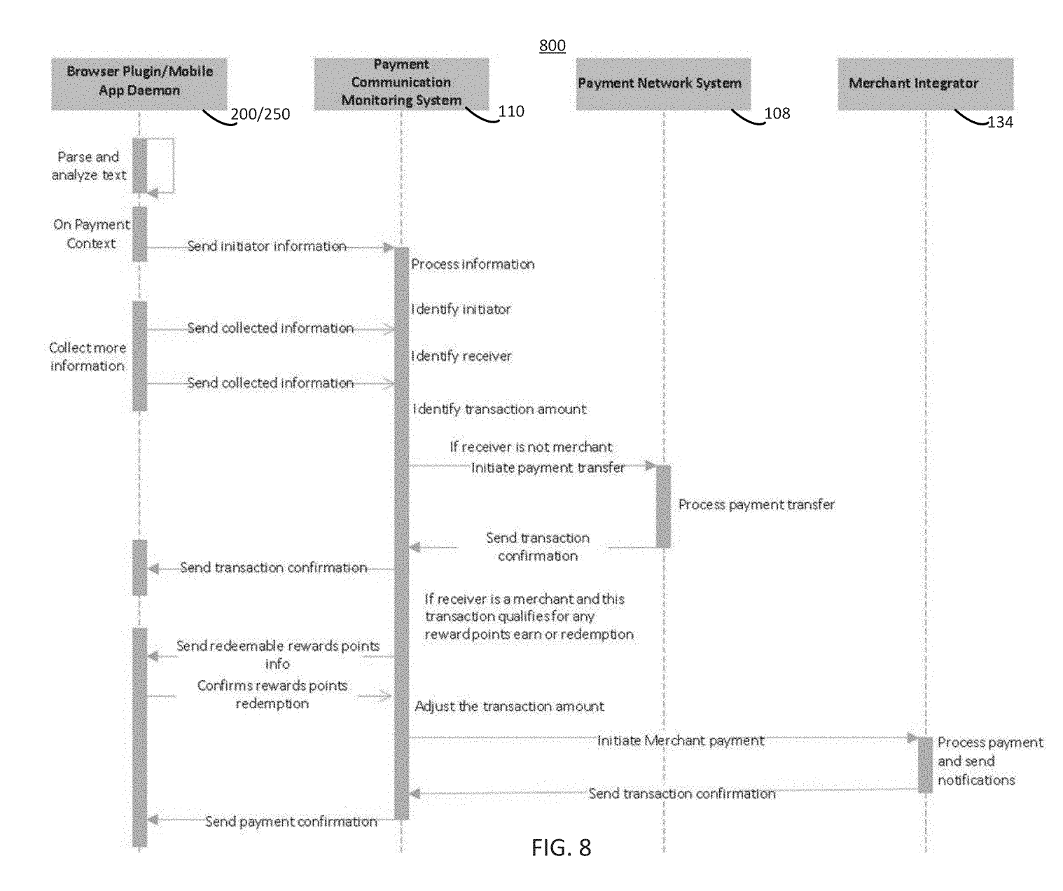

With reference to FIG. 8, a sequence diagram 800 may indicate communication of the various messages between components of the system 100. In some embodiments, communication described in relation to the methods described herein may occur between the user computer system 104 (e.g., the web browser extension 200 or the mobile app daemon 250), the payment communication monitoring system 110 (e.g., the control module 112), the payment network system 108 (e.g., the payment network module 162), and the merchant computer system 106 (e.g., the merchant integrator module 134).

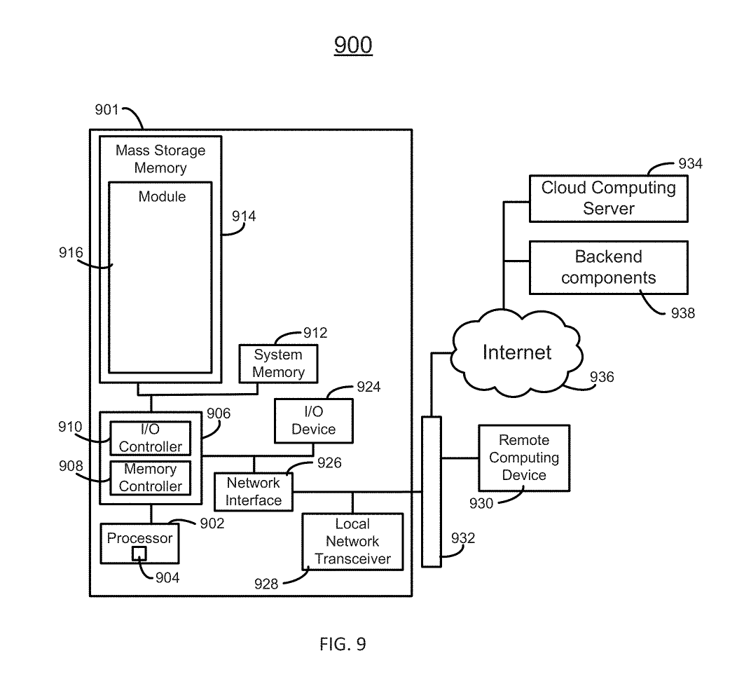

FIG. 9 is a high-level block diagram of an example computing environment 900 for the system 100 and methods (e.g., 400, 500, 600, 700, and 800) as described herein. The computing device 900 may include a server (e.g., the payment processing server 116, merchant server 129, payment server 156, mobile computing device (e.g., user computing system 104), a cellular phone, a tablet computer, a Wi-Fi-enabled device or other personal computing device capable of wireless or wired communication), a thin client, or other known type of computing device. As will be recognized by one skilled in the art, in light of the disclosure and teachings herein, other types of computing devices can be used that have different architectures. Processor systems similar or identical to the example systems and methods described herein may be used to implement and execute the example systems and methods described herein. Although the example system 1000 is described below as including a plurality of peripherals, interfaces, chips, memories, etc., one or more of those elements may be omitted from other example processor systems used to implement and execute the example systems and methods. Also, other components may be added.

As shown in FIG. 9, the computing device 901 includes a processor 902 that is coupled to an interconnection bus. The processor 902 includes a register set or register space 904, which is depicted in FIG. 9 as being entirely on-chip, but which could alternatively be located entirely or partially off-chip and directly coupled to the processor 902 via dedicated electrical connections and/or via the interconnection bus. The processor 902 may be any suitable processor, processing unit or microprocessor. Although not shown in FIG. 9, the computing device 901 may be a multi-processor device and, thus, may include one or more additional processors that are identical or similar to the processor 902 and that are communicatively coupled to the interconnection bus.

The processor 902 of FIG. 9 is coupled to a chipset 906, which includes a memory controller 908 and a peripheral input/output (I/O) controller 910. As is well known, a chipset typically provides I/O and memory management functions as well as a plurality of general purpose and/or special purpose registers, timers, etc. that are accessible or used by one or more processors coupled to the chipset 906. The memory controller 908 performs functions that enable the processor 902 (or processors if there are multiple processors) to access a system memory 912 and a mass storage memory 914, that may include either or both of an in-memory cache (e.g., a cache within the memory 912) or an on-disk cache (e.g., a cache within the mass storage memory 914).

The system memory 912 may include any desired type of volatile and/or non-volatile memory such as, for example, static random access memory (SRAM), dynamic random access memory (DRAM), flash memory, read-only memory (ROM), etc. The mass storage memory 914 may include any desired type of mass storage device. For example, the computing device 901 may be used to implement a module 916 (e.g., the various modules as herein described). The mass storage memory 914 may include a hard disk drive, an optical drive, a tape storage device, a solid-state memory (e.g., a flash memory, a RAM memory, etc.), a magnetic memory (e.g., a hard drive), or any other memory suitable for mass storage. As used herein, the terms module, block, function, operation, procedure, routine, step, and method refer to tangible computer program logic or tangible computer executable instructions that provide the specified functionality to the computing device 901, the systems and methods described herein. Thus, a module, block, function, operation, procedure, routine, step, and method can be implemented in hardware, firmware, and/or software. In one embodiment, program modules and routines are stored in mass storage memory 914, loaded into system memory 912, and executed by a processor 902 or can be provided from computer program products that are stored in tangible computer-readable storage mediums (e.g. RAM, hard disk, optical/magnetic media, etc.).

The peripheral I/O controller 910 performs functions that enable the processor 902 to communicate with a peripheral input/output (I/O) device 924, a network interface 926, a local network transceiver 928, (via the network interface 926) via a peripheral I/O bus. The I/O device 924 may be any desired type of I/O device such as, for example, a keyboard, a display (e.g., a liquid crystal display (LCD), a cathode ray tube (CRT) display, etc.), a navigation device (e.g., a mouse, a trackball, a capacitive touch pad, a joystick, etc.), etc. The I/O device 924 may be used with the module 916, etc., to receive data from the transceiver 928, send the data to the components of the system 100, and perform any operations related to the methods as described herein. The local network transceiver 928 may include support for a Wi-Fi network, Bluetooth, Infrared, cellular, or other wireless data transmission protocols. In other embodiments, one element may simultaneously support each of the various wireless protocols employed by the computing device 901. For example, a software-defined radio may be able to support multiple protocols via downloadable instructions. In operation, the computing device 901 may be able to periodically poll for visible wireless network transmitters (both cellular and local network) on a periodic basis. Such polling may be possible even while normal wireless traffic is being supported on the computing device 901. The network interface 926 may be, for example, an Ethernet device, an asynchronous transfer mode (ATM) device, an 802.11 wireless interface device, a DSL modem, a cable modem, a cellular modem, etc., that enables the system 100 to communicate with another computer system having at least the elements described in relation to the system 100.

While the memory controller 908 and the I/O controller 910 are depicted in FIG. 9 as separate functional blocks within the chipset 906, the functions performed by these blocks may be integrated within a single integrated circuit or may be implemented using two or more separate integrated circuits. The computing environment 900 may also implement the module 916 on a remote computing device 930. The remote computing device 930 may communicate with the computing device 901 over an Ethernet link 932. In some embodiments, the module 916 may be retrieved by the computing device 901 from a cloud computing server 934 via the Internet 936. When using the cloud computing server 934, the retrieved module 916 may be programmatically linked with the computing device 901. The module 916 may be a collection of various software platforms including artificial intelligence software and document creation software or may also be a Java® applet executing within a Java® Virtual Machine (JVM) environment resident in the computing device 901 or the remote computing device 930. The module 916 may also be a “plug-in” adapted to execute in a web-browser located on the computing devices 901 and 930. In some embodiments, the module 916 may communicate with back end components 938 via the Internet 936.

The system 900 may include but is not limited to any combination of a LAN, a MAN, a WAN, a mobile, a wired or wireless network, a private network, or a virtual private network. Moreover, while only one remote computing device 930 is illustrated in FIG. 9 to simplify and clarify the description, it is understood that any number of client computers are supported and can be in communication within the system 900.

Additionally, certain embodiments are described herein as including logic or a number of components, modules, or mechanisms. Modules may constitute either software modules (e.g., code or instructions embodied on a machine-readable medium or in a transmission signal, wherein the code is executed by a processor) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” or “teaching” means that a particular element, feature, structure, or characteristic described in connection with the embodiment is included in at least one embodiment. The appearances of the phrase “in some embodiments” or “teachings” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Further, the figures depict preferred embodiments for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A computer-implemented method of completing a payment transaction between parties via communication analysis, the method comprising:
intercepting communication data between a sender and a receiver;
identifying one or more of a sender unique identification and a receiver unique identification from the communication data;
pulling one or more of sender profile data corresponding to the sender unique identification and receiver profile data corresponding to the receiver unique identification;
identifying transaction data within the communication data, the transaction data including a transaction amount;
determining which of the sender or the receiver receives the transaction amount and which of the sender or the receiver sends the transaction amount;
sending a confirmation request message to one of the sender or the receiver that sends the transaction amount; and
in response to receiving a positive response to the confirmation request, processing a payment transaction for the transaction amount.

2. The method of claim 1, wherein identifying the sender unique identification from the communication data includes parsing the communication data, and identifying one or more of an address, a phone number, a name, or a MAC address.

3. The method of claim 1, further comprising determining whether one or more of the sender and the receiver are registered with a payment communication monitoring system.

4. The method of claim 3, further comprising sending a message to the sender indicating the sender is not registered if the sender is not registered with the payment communication monitoring system or sending a message to the receiver indicating the receiver is not registered if the receiver is not registered with the payment communication monitoring system.

5. The method of claim 1, wherein the transaction data includes a transaction amount, and a transaction timing.

6. The method of claim 1, further comprising determining whether the transaction data qualifies for a loyalty points or a rewards program of one or more of the sender and the receiver.

7. The method of claim 1, further comprising identifying a correlation identification from the communication data.

8. The method of claim 7, wherein the correlation identification corresponds to a loyalty rewards program.

9. The method of claim 1, wherein processing the payment transaction for the transaction amount includes sending the transaction data to a payment network system.

10. The method of claim 9, wherein processing the payment transaction for the transaction amount further includes sending one or more of a payment payload and a payment token to the receiver.

11. A system for completing a payment transaction between parties via communication analysis, the system comprising:
a mobile computing device including a processor and a memory storing instructions that, when executed by the processor, cause the processor to:
intercept communication data between a sender and a receiver;
identify one or more of a sender unique identification and a receiver unique identification from the communication data;
pull one or more of sender profile data corresponding to the sender unique identification and receiver profile data corresponding to the receiver unique identification;
identify transaction data within the communication data, the transaction data including a transaction amount;
determine which of the sender or the receiver receives the transaction amount and which of the sender or the receiver sends the transaction amount;
send a confirmation request message to one of the sender or the receiver that sends the transaction amount; and
in response to receiving a positive response to the confirmation request, process a payment transaction for the transaction amount.

12. The system of claim 11, wherein an instruction to identify the sender unique identification from the communication data includes instructions to parse the communication data, and identify one or more of an address, a phone number, a name, or a MAC address.

13. The system of claim 11, further comprising instructions to determine whether one or more of the sender and the receiver are registered with a payment communication monitoring system.

14. The system of claim 13, further comprising instructions to send a message to the sender indicating the sender is not registered if the sender is not registered with the payment communication monitoring system or instructions to send a message to the receiver indicating the receiver is not registered if the receiver is not registered with the payment communication monitoring system.

15. The system of claim 11, wherein the transaction data includes a transaction amount, and a transaction timing.

16. The system of claim 11, further comprising instructions to determine whether the transaction data qualifies for a loyalty points or a rewards program of one or more of the sender and the receiver.

17. The system of claim 11, further comprising instructions to identify a correlation identification from the communication data.

18. The system of claim 17, wherein the correlation identification corresponds to a loyalty rewards program.

19. The system of claim 11, wherein instructions to process the payment transaction for the transaction amount includes instructions to send the transaction data to a payment network system.

20. The system of claim 19, wherein instructions to process the payment transaction for the transaction amount further includes instructions to send one or more of a payment payload and a payment token to the receiver.
